(19) United States
(12) Patent Application Publication
(10) Pub. No.: US 2025/0369268 A1
(43) Pub. Date: Dec. 4, 2025

(54) VACUUM TANK DOOR LATCHING ASSEMBLY

(71) Applicant: The Charles Machine Works, Inc., Perry, OK (US)

(72) Inventor: Jim Lee, Yale, OK (US)

(21) Appl. No.: 19/215,831

(22) Filed: May 22, 2025

Related U.S. Application Data
(60) Provisional application No. 63/653,533, filed on May 30, 2024.

(51) Int. Cl. E05C 9/08; B65D 88/06; B65D 90/00; E05B 51/02; E05C 9/18

(52) U.S. Cl. CPC E05C 9/08; B65D 88/06; B65D 90/008; E05B 51/02; E05C 9/1808; E05C 9/1891

(57) ABSTRACT

A door latching mechanism for a tank door. The mechanism includes a rotating shaft with integral tabs. A central tab rotates in response to actuation by a cylinder or other actuator. Outwardly disposed tabs are rotatably connected to hooks which have a specific geometry, allowing them to latch onto shackles on the side of the tank. When latched, the tab's orientation is over center, such that positive force is not needed to maintain the tank in the latched position. The hooks may be concave up or concave down depending upon the geometry of the remainder of the latching mechanism. When unlatched, a single powered hinge may allow the tank to be open, and gravity assists with the disposal of spoils contained therein.

### SUMMARY

The present invention is directed to a vacuum tank. The tank comprises a tank body, a door, and a latching mechanism. The tank body has an open end. The door is attached to the tank body at a hinge and configured to cover the open end. The latching mechanism comprises a shaft, a first end tab, a second end tab, a first hook, a second hook and a central tab.

The shaft extends across the door from a first end to a second end. The first end tab and second end tab are rotationally coupled to the first and second end of the shaft, respectively. The first hook and second hook are pivotally attached to first end tab and the second end tab, respectively. The central tab is rotationally coupled to the shaft between the first end and the second end. The shaft is rotatable from a first position to a second position.

The invention is also directed to a latching mechanism for a door on a tank body. The latching mechanism comprises a shaft, a pair of tabs, a pair of hooks, and a pair of shackles. The shaft extends across the door and is rotatable by a single actuator. The actuator is configured to rotate the shaft about an axis. The pair of tabs extend from opposite ends of the shaft and are rotatable with the shaft. The pair of hooks are each pivotally attached to the pair of tabs at a hook pivot and extend to a concave hooked connection.

The pair of shackles are each attached to the tank body at opposite ends, and configured to engage a selected one of the pair of hooks at the concave hooked connection. The latching mechanism rotates over center when the pair of shackles engage the pair of hooks.

### BRIEF DESCRIPTION OF THE DRAWINGS

FIG. 1 is a rear top side view of a vacuum tank. The tank has a door latching mechanism extending across its periphery.

FIG. 2 is a side view thereof, with the vacuum tank tilted. It should be understood that the vacuum tank sits on a trailer or other supporting frame (not shown) and may be tilted by an actuator, such as a hydraulic cylinder or other actuator known in the art.

FIG. 3 is a top rear side perspective view of the door latching mechanism. The door latching mechanism has hooks attached to brackets which are shown in the latched position in FIG. 3. An actuator is shown attached to a central tab, which causes rotation of the mechanism.

FIG. 4A is the view of the door latching mechanism of FIG. 3, with the actuator removed. The mechanism is shown in the latched position.

FIG. 4B is the door latching mechanism of FIG. 4A with the central tab rotated such that the door latching mechanism is in an unlatched position.

FIG. 5 is a cutaway detail view of one end of the door latching mechanism, detailing an interface between the shaft, an outwardly disposed tab, the hook, and a shackle.

FIG. 6 is a cutaway detail view of one end of an alternative door latching mechanism, with the hook upwardly-facing.

FIG. 7A is a top side front perspective view of a hook for use with the door latching mechanism.

FIG. 7B is a side view thereof.

FIG. 8A is side view of the hook, shackle, and outwardly disposed tab of the door latching mechanism of FIG. 4A, with the mechanism in a latched position relative to the shackle. A line is shown between the pivot point at which the hook and the tab connect and the shackle. The connection point between the tab and shaft is on a first side of the line when in the latched position.

FIG. 8B is the view of FIG. 8A with the mechanism in an unlatched position. The connection point between the tab and shaft is on a second side of the line when in the unlatched position.

### DETAILED DESCRIPTION

The figures and below description describe a vacuum tank 10. A vacuum tank is used to store and transport excavated spoils away from a job site. Spoils are the combination of drilling fluid and wet, displaced mud or soil, that may be produced at the location of a horizontal directional drilling operation.

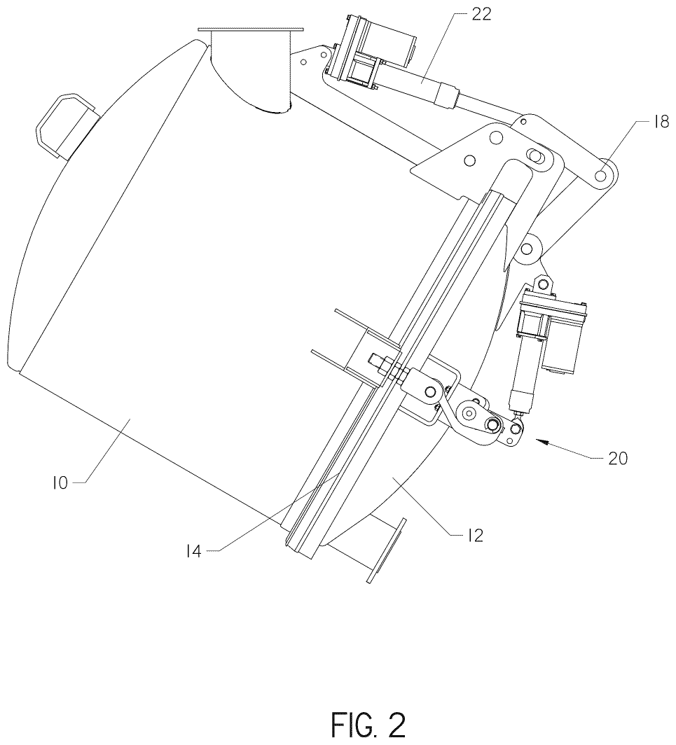

Often, wet spoil and drilling fluid is transported from a job site, where it is removed from a borehole, to a disposal site where it can be dumped for storage, disposal, or further processing. As a result, vacuum tanks 10 are mounted on a truck or trailer, and either have a sloped bottom, or are tiltable, as shown in FIG. 2, allowing gravity to assist in removing spoils from the tanks.

To date, vacuum tanks 10 typically utilize one of two systems to open and latch their doors. First, some tanks have paired, powered opening and latching mechanisms on each side of the tank. These mechanisms may apply continuous force (through hydraulic pressure or otherwise) or, preferably, break over center to latch the door. However, such powered door opening mechanisms often require operation of multiple cylinders, and pairing of the components across the width of the tank, often with an internal shaft which allows side-mounted opening mechanisms to lift simultaneously. Accordingly, they are best suited for large tanks which may support these apparatuses without compromising space and power.

Alternatively, existing small vacuum tanks may have a top-mounted door opening hinge (whether powered or not) which are latched by manually operated wheel clamps, which are either centrally mounted or mounted at the periphery of the door. While such mechanisms are simple and can fit on small tanks, they require an operator to stand near the door during the unlatching process. It is often an unavoidable consequence of such systems that spoils spill out of the back of the tank 10 onto the operator.

It is therefore advantageous to have a powered door mechanism which will allow the use of a single actuator (to avoid the space problems intrinsic to using paired actuators on each side) but also allow the robust clamping mechanisms provided by larger systems.

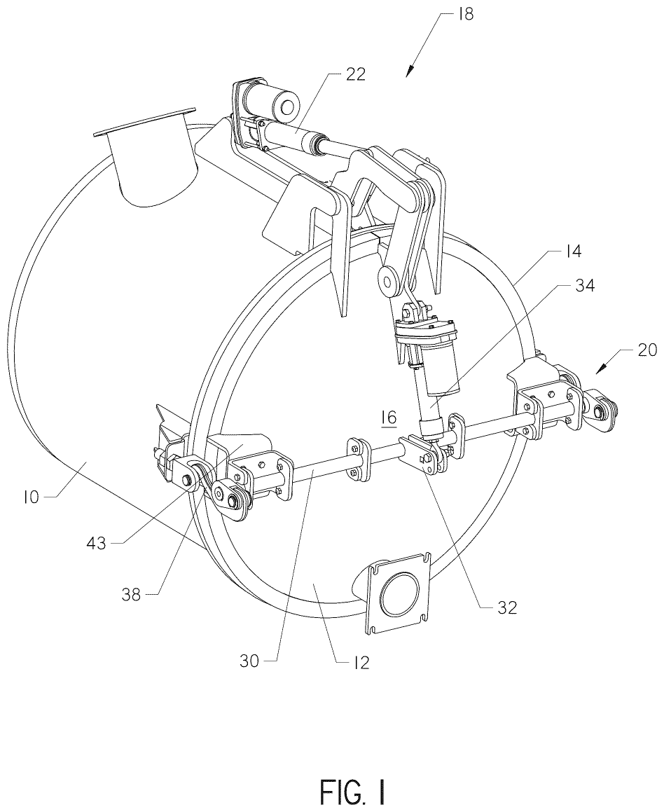

With reference to FIG. 1, a door latching mechanism 20 is shown for use on a vacuum tank 10. The vacuum tank 10 is enclosed by a door 12 with a circular periphery 14. The door is either circular or is domed such that a center 16 of the door extends outwardly from its periphery 14.

The door 12 is attached to the tank 10 by a hinge assembly 18. The hinge assembly 18 in FIG. 1 is at a top of the periphery 14, meaning that as the door 12 opens, the bottom edge opens widely first. The hinge assembly 18 may be operated by a hydraulic cylinder 22 or other actuator.

In FIGS. 1 and 2, the door latching mechanism 20 comprises a rotating shaft 30, a central tab 32, an actuator 34, first and second outwardly disposed tabs 36, and first and second hooks 38. Locating brackets 40 and wear brackets 42 are spaced along the length of the shaft 30 on the door 12. Each hook 38 is configured to interact with a shackle 50. Each shackle 50 is mounted to a bracket 52 which is attached to a side of the tank 10.

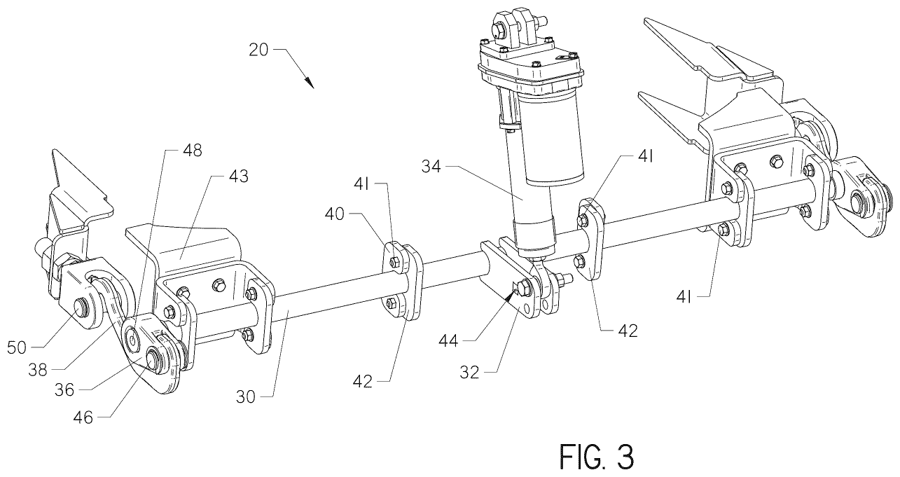

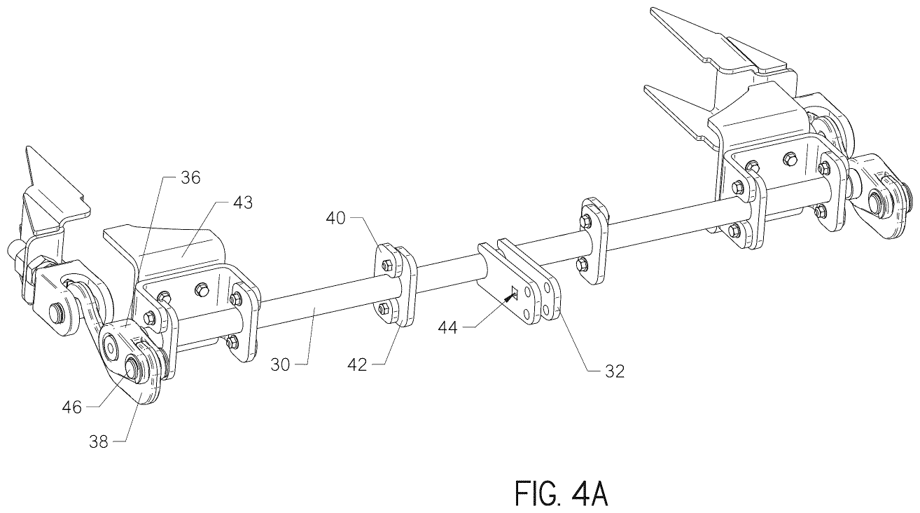

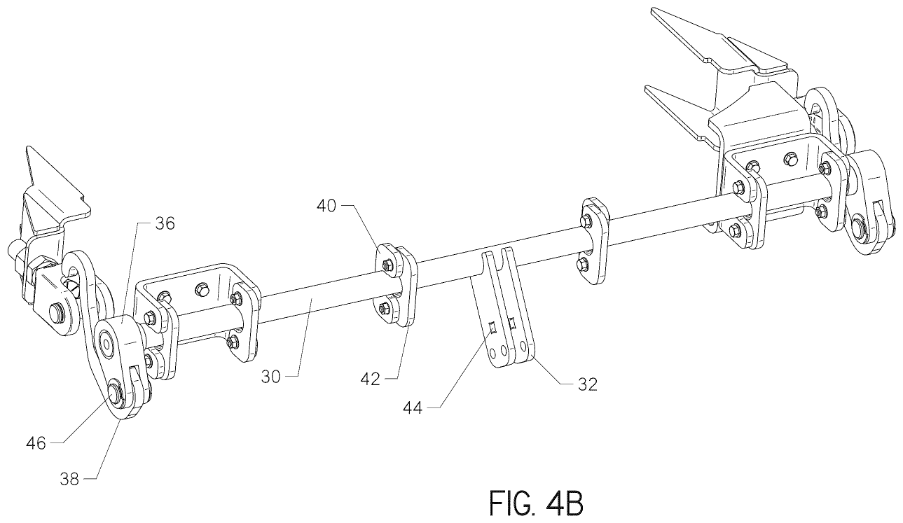

With reference to FIGS. 3 and 4A-4B, the door latching mechanism 20 is shown with the vacuum tank 10 and door 12 hidden. The locating brackets 40 should be understood to be fixedly attached—whether welded or otherwise connected—to the door 12. As shown, some of the locating brackets 40 are disposed on extended frame elements 43 which are attached to the door. The frame elements 43 allow the location of brackets 40, 42 to accommodate a linear shaft 30 in the case of a domed door 12. Should the door 12 be circular without any dome, the location brackets 40 may all be directly attached to the door 12 without the need for the frame elements 43. Each wear bracket 42 is attached to a corresponding locating bracket 40 by a pair of bolts.

The wear bracket 42 preferably guides and contacts the rotating shaft 30, while the locating bracket 40 does not. The wear brackets 42 are removable and replaceable as they wear. Further, wear brackets 42 may be removed when refurbishment, repair, or replacement of the shaft 30 is required. As shown, bolts 41 connect the paired brackets 40, 42, though other attachment mechanisms may be used.

The actuator 34 may be a linear screw, hydraulic cylinder, or other mechanism. In the configuration shown, the actuator 34 extends to unlatch the latching mechanism 20. Specifically, the actuator 34 causes the central tab 32 to rotate. Each of the central tabs 32, rotating shaft 30, and outwardly disposed tabs 36 are integral and rotate together. The central tab 32 has an aperture 44 for placement of a tool in case of a failure of the actuator 34, so that the door 12 may be opened even in the case of such a failure.

The outwardly disposed tabs 36 are each disposed at an end of the shaft 30 at a connection point 48. The outwardly disposed tabs 36 are connected to the hook 38 at a hook pivot 46. The hook pivot 46 allows relative rotation between the hook 38 and the attached tab 36.

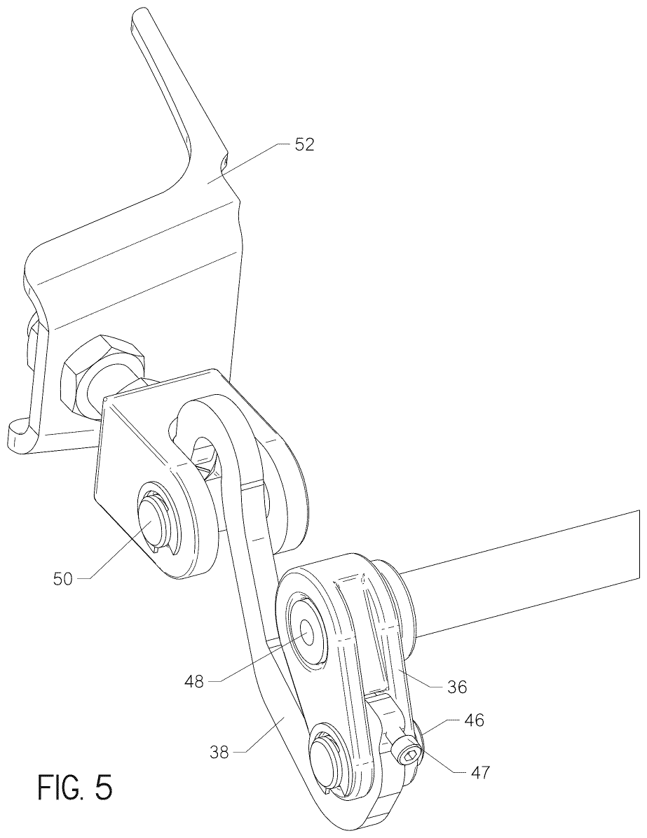

In the latched position, as shown in FIGS. 3-4A, the hook pivot is “over center”, in the sense that the connection point 48 between the outward tabs 36 and shaft 30 is below a line between the shackle 50 and the hook pivot 46. When unlatched, as shown in FIGS. 4B and 5, the connection point 48 is above a line between the outward tabs 36 and the shackle 50. By providing an “over center” linkage, the latching mechanism 20 does not tend to unlatch—that is, positive force is not required to maintain the hook 38 in a latched position. Essentially, the pivot point 46 allows the latching mechanism to act as an over-center cam, actuated by the actuator 34.

An adjustment bolt 47 may adjust a position of the hook 38 relative to the outward tab 36. This bolt 47 helps to account for manufacturing variances which may exist, allowing the linkage to be tuned such that the hook 38 meets the shackle 50 in an “over center” position with the linkage at rest. While the adjustment bolt 47 is only shown in FIG. 5, it should be understood that the bolt may be positioned near the hook pivot 46 (or elsewhere) in the linkage as shown in each of the figures.

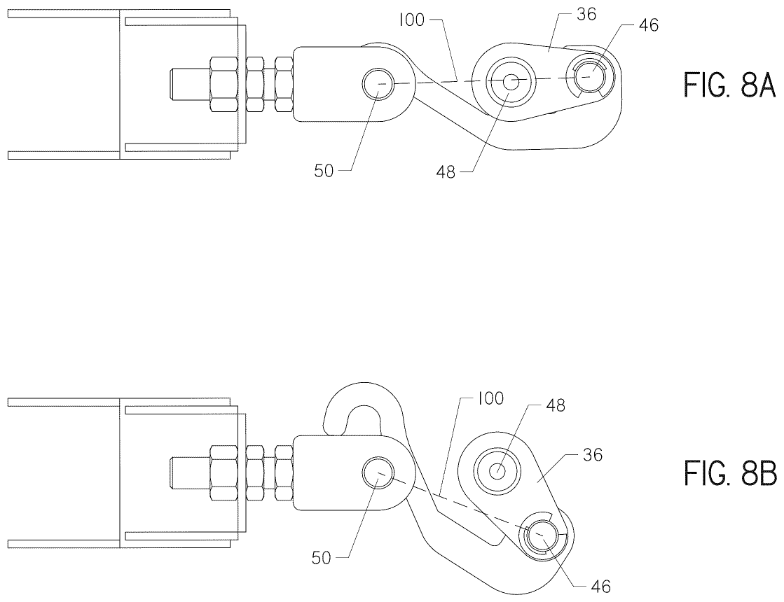

The “over center” aspect of the invention is best shown in FIGS. 8A and 8B. A line 100 is drawn between shackle 50 and pivot point 46 in each figure. In FIG. 8B, the connection point 48 is above the line 100. However, when the apparatus is latched, as in FIG. 8A, the connection point 48 must be brought across the line 100.

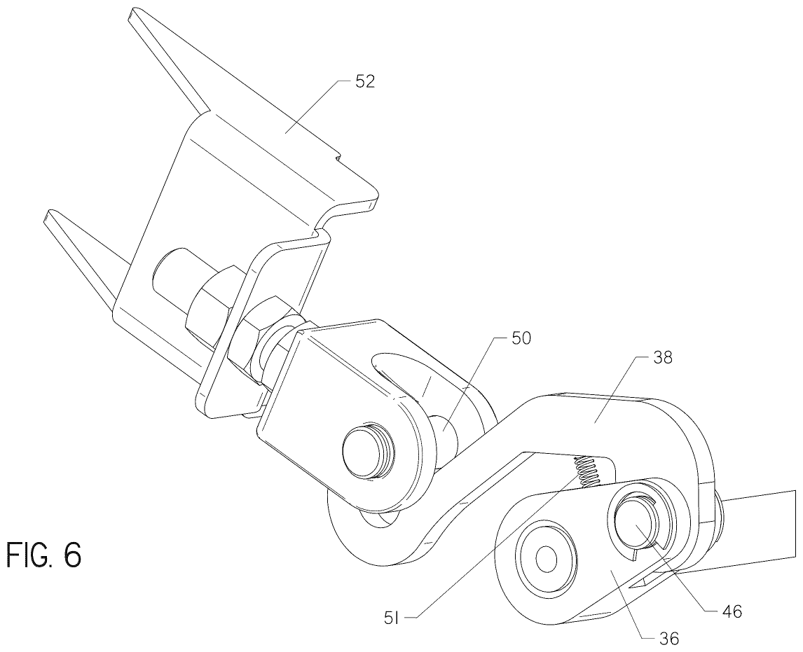

With reference to FIG. 6, a different orientation of the hook 38 is shown. In FIG. 6, the hook 38 is “concave up” at the shackle 50, with a spring 51 used to facilitate the makeup between the hook and the shackle. In FIG. 5, with the hook “concave down” at the shackle 50, gravity assists in positioning the hook around the shackle. Either orientation may be used without departing from the spirit of the invention.

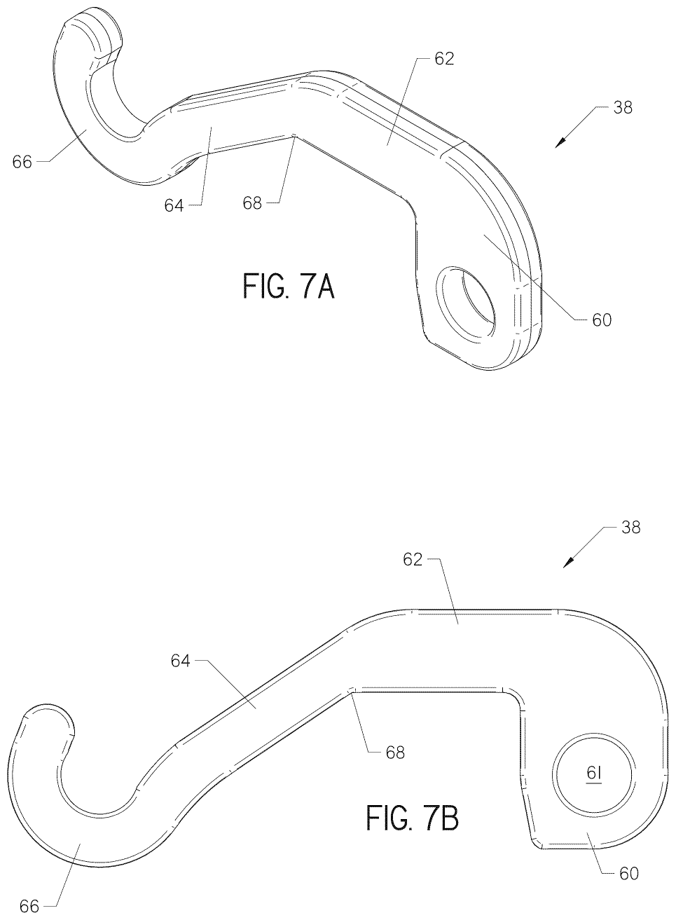

The hook 38, as shown in FIGS. 7A-7B, has a tab 60 containing an aperture 61 for linking the hook to the pivot connection 46, a first section 62, a second section 64, and a hooked connector 66. The hooked connector 66 is sized to mate with the shackle 50. The second section 64 is angled relative to the first section 62 to allow the “over center” geometry of the hook 38.

In the embodiment of FIG. 6, rotation of the shaft 30 and outward tab 36 causes the spring 51 to compress, placing a force against the first section 62, rotating the hooked connector 66 toward the shackle 50. In the embodiment of FIG. 5, the tab 36 contacts the first section 62, causing the rotation of the hook 38. Closing the latch mechanism 20 may result in connection point 48 or the shaft 30 being seated against a transition point 68 between the first section 62 and the second section 64 of the hook 38.

The various features and alternative details of construction of the apparatuses described herein for the practice of the present technology will readily occur to the skilled artisan in view of the foregoing discussion, and it is to be understood that even though numerous characteristics and advantages of various embodiments of the present technology have been set forth in the foregoing description, together with details of the structure and function of various embodiments of the technology, this detailed description is illustrative only, and changes may be made in detail, especially in matters of structure and arrangements of parts within the principles of the present technology, without departing from the spirit of the invention.

1. A vacuum tank comprising:
a tank body having an open end;
a door, attached to the tank body at a hinge and configured to cover the open end; and
a latching mechanism, comprising:
a shaft extending across the door from a first end to a second end;
a first end tab, rotationally coupled to the first end of the shaft;
a second end tab, rotationally coupled to the second end of the shaft;
a first hook, pivotally attached to the first end tab at a first hook pivot;
a second hook, pivotally attached to the second end tab at a second hook pivot; and
a central tab rotationally coupled to the shaft between the first end and the second end;
wherein the shaft is rotatable from a first position to a second position.

2. The vacuum tank of claim 1 further comprising:
a first shackle disposed on the tank body proximate the first end of the shaft;
a second shackle disposed on the tank body proximate the second end of the shaft;
wherein the first hook engages the first shackle and the second hook engages the second shackle when the shaft is in the first position.

3. The vacuum tank of claim 2 in which:
in the first position:
the axis of the shaft is on a first side of a line between the first shackle and the first hook pivot; and
in the second position:
the axis of the shaft is on a second side of the line between the first shackle and the first hook pivot.

4. The vacuum tank of claim 1 further comprising:
a latch actuator extending from the door to the central tab, wherein extension and retraction of the latch actuator is configured to rotate the shaft between the first position and the second position.

5. The vacuum tank of claim 4 in which the latch actuator comprises one and only one hydraulic cylinder.

6. The vacuum tank of claim 1, in which a powered actuator is operable to rotate the door about the hinge when the shaft is in the second position.

7. The vacuum tank of claim 1 further comprising a plurality of brackets mounted to the door, in which the shaft is situated within each of the plurality of brackets.

8. The vacuum tank of claim 7 in which each of the plurality of brackets comprises:
a locating bracket, fixedly attached to the door; and
a wear bracket, removably attached to the locating bracket;
in which the shaft contacts the wear bracket and not the locating bracket.

9. The vacuum tank of claim 8 in which the wear bracket is removably attached to the locating bracket by bolts.

10. The vacuum tank of claim 1 in which the door is dome-shaped.

11. The vacuum tank of claim 1 in which the first hook comprises a concave hooked connector, in which the concave hooked connector is disposed at a first end of the first hook and the first hook pivot is disposed at a second end of the first hook.

12. The vacuum tank of claim 11 in which the tank body comprises a first shackle disposed on the tank body proximate the first end of the shaft, in which the concave hooked connector of the first hook is configured to engage the first shackle when the shaft is in the first position.

13. The vacuum tank of claim 12 in which a reference line is defined between a centerpoint of the first hook pivot and a centerpoint of the first shackle, in which the axis of the shaft is on a first side of the reference line when the shaft is in the first position, and a second side of the reference line when the shaft is in the second position.

14. The vacuum tank of claim 11 in which the concave hooked connector opens in a downward direction when the shaft is in the first position.

15. The vacuum tank of claim 11 in which the first hook further comprises:
a tab, containing an aperture locating the first hook pivot;
a first section, extending from the tab;
a second section, angled relative to the first section and meeting the first section at a transition point, such that the concave hooked connector extends from the second section at an opposite end of the second section from the transition point.

16. The vacuum tank of claim 15 in which the shaft is seated against the first hook at the transition point when the shaft is in the first position.

17. A latching mechanism for a door on a tank body, the latching mechanism comprising:
a shaft, extending across the door and rotatable by a single actuator, the actuator configured to rotate the shaft about an axis;
a pair of tabs extending from opposite ends of the shaft and rotatable with the shaft;
a pair of hooks, each of the pair of hooks pivotally attached to the pair of tabs at a hook pivot and extending to a concave hooked connection; and
a pair of shackles, each of the pair of shackles attached to the tank body at an opposite end, in which the pair of shackles are configured to engage a selected one of the pair of hooks at the concave hooked connection;
wherein the latching mechanism rotates over center when the pair of shackles engage the pair of hooks.

18. The latching mechanism of claim 17 further comprising a plurality of locating brackets disposed about the shaft and rigidly attached to the door.

19. The latching mechanism of claim 17 further comprising a powered hinge, configured to open the door when the pair of shackles do not engage the pair of hooks.

20. The latching mechanism of claim 17 in which:
the concave hooked connection opens in an upward direction when the pair of hooks are engaged with the pair of shackles; and
a spring extends from each of the pair of tabs to its corresponding one of the pair of hooks.
